(19) United States
(12) Patent Application Publication
(10) Pub. No.: US 2026/0208087 A1
(43) Pub. Date: Jul. 23, 2026

(54) FILTER ASSEMBLY, RELATED FILTER ELEMENTS AND HOUSING COVER

(71) Applicant: Donaldson Company, Inc., Bloomington, MN (US)

(72) Inventors: Gunther VAN DE POEL, Waanrode (BE); Tim BILLIAU, Bierbeek (BE); Mathijs VERSTRAETE, Tienen (BE)

(73) Assignee: Donaldson Company, Inc., Bloomington, MN (US)

(21) Appl. No.: 19/150,260

(22) PCT Filed: Jan. 23, 2024
(86) PCT No.: PCT/US2024/012661

§ 371 Date: Jul. 23, 2025

Related U.S. Application Data
(60) Provisional application No. 63/440,651, filed on Jan. 23, 2023.

(51) Int. Cl. B01D 46/24; B01D 46/00; B01D 46/10; B01D 46/64

(52) U.S. Cl. CPC B01D 46/2414; B01D 46/0004; B01D 46/10; B01D 46/64; B01D 2265/021; B01D 2265/026; B01D 2271/027

(57) ABSTRACT

The present disclosure relates to a filter assembly comprising a filter housing and a primary and secondary filter element coaxially arranged about an axis, within said housing along a fluid flow path between an inlet of the housing and an outlet of the housing, wherein an outer surface of a closed first end cap of a secondary element is adapted and arranged for interacting with an inner surface of a closed first end cap of a primary filter element during installation of the primary filter element so as to convert a pushing force exerted on the primary element towards the secondary element into a rotational movement of the primary element up until a first predetermined angular position, followed by a translational movement of the primary filter element towards the secondary filter element in a direction along said axis when said first predetermined angular position is reached.

### RELATED APPLICATION

This application is being filed on Jan. 23, 2024, as a PCT International Patent Application and claims the benefit of and priority to U.S. Provisional Patent Application No. 63/440,651, filed on Jan. 23, 2023, the disclosure of which is incorporated herein by reference in its entirety.

### FIELD OF THE DISCLOSURE

The present disclosure relates to the field of gas filtration, such as for instance air filtration. It relates to an air filter assembly comprising a main or primary filter element and a safety or secondary filter element which are arranged in a filter housing along a fluid flow path between an inlet of the housing and an outlet of the housing.

### BACKGROUND

Filter elements, also named filter cartridges, are used for a wide variety of filtering applications and the fluid to be filtered can be a liquid or a gas, e.g. air.

Indeed, in many instances, it is desired to filter contaminant material from a fluid stream. For example, airflow streams to engines for motorized vehicles or for power generation equipment, construction equipment or other equipment, gas streams to gas turbine systems and air streams to various combustion furnaces, carry particulate contaminant therein. It is preferred for such systems that contaminant materials be removed from the fluid or at least be reduced.

Filter elements comprise filter media for removing contaminant materials when the fluid flows through the filter media. Commonly used and commercially available filter media are for example pleated media or fluted media. When the filter media is loaded with dust and/or particles above a certain threshold load, a filter element needs to be replaced. Filter elements are typically installed in the housing in a replaceable manner.

In many filtration applications, use is made of a primary (main) filter element and a secondary (safety) filter element, arranged along a fluid flow path between an inlet and an outlet of a filter housing. A safety filter element positioned downstream of the main filter element can then for instance protect the engine or equipment when servicing the main filter element, or when the main filter element would be damaged. Main filter elements are typically replaced more frequently than safety filter elements.

It is generally important to install correct filter elements, in a correct manner, for a certain filter housing in order to avoid damage to the equipment or engine which makes use of the filtered air/gas.

In many instances, filter elements have to be placed into the respective filter housing of an air cleaner or filter assembly without easy access (for instance at a certain height in the engine space of a vehicle) and/or in conditions where the internal volume of the filter housing cannot be seen by the servicing person.

There is a need in industry for new solutions which allow an easy installation of a correct main element in a filter housing which is adapted for receiving both a safety and a main filter element, and which would not allow the installation of a wrong filter element.

### SUMMARY

It is an object of embodiments of the present disclosure to provide a filter assembly comprising a filter housing and a primary and secondary filter element coaxially arranged about an axis, within the housing along a fluid flow path between an inlet of the housing and an outlet of the housing, which comprises a reduced risk of installing a wrong filter element.

A further object of embodiments of the present disclosure is to simplify installation and reduce the risk of an incorrect installation of a correct filter element.

The present invention is defined in the appended claims.

According to a first aspect of the present disclosure, a filter assembly can include a filter housing and a primary and secondary filter element coaxially arranged about an axis, within the housing along a fluid flow path between an inlet of the housing and an outlet of the housing, wherein both the primary and secondary elements comprise respective first and second filter media packs, each extending between a respective closed first end cap at a first end and a respective second end cap at a second end of the filter media packs, wherein an outer surface of the closed first end cap of the secondary element is adapted and arranged for interacting with an inner surface of the closed first end cap of the primary filter element during installation of the primary filter element so as to convert a pushing force exerted on the primary element towards the secondary element into a rotational movement of the primary element up until a first predetermined angular position, followed by a translational movement of the primary filter element towards the secondary filter element in a direction along the axis when the first predetermined angular position is reached.

According to preferred embodiments, the axis is substantially horizontal in use.

According to preferred embodiments, the first end cap of the primary filter element comprises a centrally positioned, inwardly protruding support structure and a guiding structure radially extending from a longitudinal sidewall of the support structure; the first end cap of the secondary filter element comprises a slanted surface for receiving the guiding structure of the primary filter element and guiding it to a second predetermined angular position corresponding to the first predetermined angular position of the primary element; and the first end cap of the secondary filter element comprises an axially extending receiving structure for receiving the guiding structure of the primary filter element when the guiding structure has reached the second predetermined position.

According to preferred embodiments, the guiding structure comprises a rib or fin radially extending from the inwardly protruding support structure.

According to preferred embodiments, the axially extending receiving structure comprises an axially extending elongated trench or slot.

According to preferred embodiments, the inwardly protruding support structure comprises an inwardly protruding tube-like structure.

According to preferred embodiments, the tube-like structure comprises a cylindrical internal volume, and the guiding structure extends radially inwardly from an internal surface of the inwardly protruding tube-like structure.

According to preferred embodiments, the slanted surface is embodied as a closing end surface of the tube-like protrusion of the first end cap of the secondary filter element.

According to preferred embodiments, the slanted surface evolves from a highest axial position to a lowest axial position over a radial extent of less than 180 degrees.

According to preferred embodiments, the guiding structure extends radially outwardly from an external surface of the inwardly protruding tube-like structure.

According to preferred embodiments, the slanted surface is embodied as a spiralling surface arranged in a recess of the first end cap of the secondary filter element.

According to preferred embodiments, the slanted surface evolves from a highest axial position to a lowest axial position in a spiralling way over an axial extent of more than 180 degrees.

According to preferred embodiments, the slanted surface evolves from a highest axial position to a lowest axial position in a spiralling way over an axial extent of less than 180 degrees.

According to preferred embodiments, the second end cap of the primary filter element comprises axially extending element locking features, and the filter housing comprises corresponding housing locking features suitable for receiving the filter locking features and cooperating with them in order to block any relative rotation of the primary filter element with respect to a housing axis, the locking features being arranged and adapted to provide the rotational locking after the primary element has reached the first predetermined angular position and before the end of the translational movement.

According to preferred embodiments, the secondary filter element comprises a circumferential seal for sealing towards the primary filter element near the second end of the secondary filter element, and the primary filter element comprises a circumferential sealing surface near its second end, the sealing surface and seal being arranged and adapted as to seal in a single or a limited number of relative angular positions.

According to preferred embodiments, the first predetermined angular position of the primary filter element corresponds to a sealing configuration between the circumferential sealing surface of the primary filter element and the circumferential seal of the secondary filter element.

According to preferred embodiments, the circumferential seal comprises at least one axial step.

According to preferred embodiments, the filter assembly further comprises a housing cover which comprises a cover guiding structure adapted and arranged to interact with the inwardly protruding support structure and the guiding structure of the primary filter element so as to define a single relative angular position with respect to the primary filter element.

According to preferred embodiments, the guiding structure of the primary filter element extends radially outwardly from an external surface of the inwardly protruding tube-like structure, and the inwardly protruding tube-like structure abuts on an axial end surface. The internal surface of the inwardly protruding tube-like structure and the guiding structure and the axial end surface define a pocket. The internal surface of the guiding structure of the primary filter element defines an axially extending recess of the pocket, and the housing cover comprises an axially inwardly directed cover protrusion and a cover guiding structure extending radially from an outer wall of the axially inwardly directed cover protrusion. The pocket is adapted for receiving the axially inwardly directed cover protrusion in a predetermined relative angular orientation, the predetermined relative angular orientation being defined by the reception of the cover guiding structure into the axially extending recess of the pocket.

According to a second aspect of the present disclosure, a filter element for use in an assembly according to any of the embodiments of the first aspect is disclosed, comprising a media pack extending between a closed first end cap at a first end and a second end cap at a second end, the first end cap of the primary filter element comprising a centrally positioned, inwardly protruding support structure and a guiding structure radially extending from a longitudinal sidewall of the support structure.

According to preferred embodiments, the guiding structure comprises a rib or fin radially extending from the inwardly protruding support structure.

According to preferred embodiments, the inwardly protruding support structure comprises an inwardly protruding tube-like structure.

According to preferred embodiments, the tube-like structure comprises a cylindrical internal volume and the guiding structure extends radially inwardly from an internal surface of the inwardly protruding tube-like structure.

According to preferred embodiments, the guiding structure extends radially outwardly from an external surface of the inwardly protruding tube-like structure.

According to preferred embodiments, the (main or primary) filter element does not comprise a seal.

According to preferred embodiments, the second end cap of the primary filter element comprises axially extending element locking features, such as at least one or a plurality of axially extending locking pins or openings for receiving locking pins.

According to a third aspect of the present disclosure, a (secondary) filter element for use in an assembly according to any of the embodiments of the first aspect is disclosed, comprising a media pack extending between a closed first end cap at a first end and a second end cap at a second end, wherein the first end cap of the filter element comprises a slanted surface for receiving the guiding structure of the primary filter element according to any of the embodiments of the second aspect, and for guiding it to a predetermined angular position, and comprises an axially extending receiving structure for receiving the guiding structure of the primary filter element when the guiding structure has reached the second predetermined position.

According to a fourth aspect of the present disclosure, a filter housing cover for use in an assembly according to any of the embodiments of the first aspect is disclosed, wherein the housing cover comprises an axially inwardly directed cover protrusion and a cover guiding structure extending radially from an outer wall of the axially inwardly directed cover protrusion.

Any of the embodiments described for any of the four aspects are also meant to be disclosed for any of the three other aspects, mutatis mutandis. For instance, any features described for the housing cover and primary and secondary filter elements in the context of the filter assembly are meant to be disclosed also for the respective filter elements and housing cover.

In one example of the disclosure, an air cleaner assembly can include a filter housing assembly defining an inlet and an outlet; a primary filter element disposed within the housing and along a fluid flow path between the housing inlet and outlet, the primary filter element including a first media pack; and a secondary filter element coaxially arranged with the primary filter within the housing and along the fluid flow path, the secondary filter element including a second media pack; a positioning arrangement including a first part associated with the primary filter element and a second part associated with the secondary filter element, wherein the first part interacts with the second part such that, during installation of the primary filter element, a pushing force on the primary filter element in a direction towards said secondary element is converted into a rotational movement of the primary element up until a first predetermined angular position, followed by a translational movement of the primary filter element towards said secondary filter element in a direction along said axis when the first predetermined angular position is reached. In some examples, the first part is a radially inward facing surface defined by the primary filter element. In some examples, the radially inward facing surface is defined by an end cap of the primary filter element. In some examples, the second part is a radially outward facing surface defined by the secondary filter element. In some examples, the radially outward facing surface is defined by an end cap of the secondary filter element. In some examples, one or both of the first and second part includes a slanted surface. In some examples, one or both of the first and second parts has single fold rotational symmetry. In some examples, one or both of the primary and secondary filter elements has single fold rotational symmetry.

### BRIEF DESCRIPTION OF THE DRAWINGS

These and further aspects of the present disclosure will be explained in greater detail by way of example and with reference to the accompanying drawings.

FIG. 1 is a schematic side view of an air cleaner having features in accordance with the present disclosure.

FIG. 2 is a schematic side view of the air cleaner shown in FIG. 1, with a cover of the air cleaner removed and showing a primary filter element of the air cleaner assembly in a partially installed state.

FIG. 3 is schematic end view of the air cleaner shown in FIG. 1.

FIG. 4 is a schematic cross-sectional side view of the air cleaner shown in FIG. 1, without the cover installed and taken along the line 4-4 in FIG. 2, whereby it can be seen that the air cleaner assembly includes the primary filter element and a secondary filter element.

FIG. 5 is a schematic top view of a portion of the primary filter element shown in FIG. 4.

FIG. 6 is a schematic cross-sectional side view of the primary filter element portion shown in FIG. 4.

FIG. 7 is a schematic cross-sectional side view of a portion of the secondary filter element shown in FIG. 4.

FIG. 8 is a schematic first perspective view of the primary filter element portion of FIG. 4 coaxially aligned and spaced from the secondary filter element portion shown in FIG. 7.

FIG. 9 is a schematic second perspective view of the primary filter element portion of FIG. 4 coaxially aligned and spaced from the secondary filter element portion shown in FIG. 7.

FIG. 10 is a schematic end view of the secondary filter element portion shown in FIG. 7.

FIG. 11 is a schematic cross-sectional side view of the secondary filter element portion shown in FIG. 7.

FIG. 12 is a schematic perspective view of the secondary filter element portion shown in FIG. 7.

FIG. 13 is a schematic cross-sectional side view of the primary filter element portion of FIG. 4 in a fully installed position with respect to the secondary filter element portion shown in FIG. 7.

FIG. 14 is a schematic first perspective view of the primary filter element portion and secondary filter element portion shown in FIG. 13.

FIG. 15 is a schematic second perspective view of the primary filter element portion and secondary filter element portion shown in FIG. 13.

FIG. 16 is a schematic cross-sectional side view of the primary filter element portion of FIG. 4 in a partially installed position with respect to the secondary filter element portion shown in FIG. 7.

FIG. 17 is a schematic first perspective view of the primary filter element portion and secondary filter element portion shown in FIG. 16.

FIG. 18 is a schematic second perspective view of the primary filter element portion and secondary filter element portion shown in FIG. 16.

FIG. 19 is a schematic cross-sectional side view of the air cleaner assembly shown in FIG. 1 with a second example of a primary filter element and a second example of a secondary filter element, wherein the primary filter element is shown in a partially installed state.

FIG. 20 is a schematic side view of the secondary filter element shown in FIG. 19.

FIG. 21 is a schematic first end view of the secondary filter element shown in FIG. 20.

FIG. 22 is a schematic second end view of the secondary filter element shown in FIG. 20.

FIG. 23 is a schematic perspective view of the secondary filter element shown in FIG. 20.

FIG. 24 is a schematic side view of the primary filter element shown in FIG. 19.

FIG. 25 is a schematic first end view of the primary filter element shown in FIG. 24.

FIG. 26 is a schematic second end view of the primary filter element shown in FIG. 24.

FIG. 27 is a schematic first perspective view of the primary filter element shown in FIG. 24.

FIG. 28 is a schematic second perspective view of the primary filter element shown in FIG. 24.

FIG. 29 is a schematic side view of the primary filter element of FIG. 19 in a first partially installed position with respect to the secondary filter element shown in FIG. 19.

FIG. 30 is a schematic side cross-sectional view of the primary filter element and secondary filter element shown in FIG. 29.

FIG. 31 is a schematic side view of the primary and the secondary filter elements shown in FIG. 29 with the primary filter element in a further installed second partially installed position.

FIG. 32 is a schematic side cross-sectional view of the primary filter element and secondary filter element shown in FIG. 31.

FIG. 33 is a schematic side view of the primary and the secondary filter elements shown in FIG. 31 with the primary filter element in a further installed third partially installed position.

FIG. 34 is a schematic side cross-sectional view of the primary filter element and secondary filter element shown in FIG. 33.

FIG. 35 is a schematic side view of the primary and the secondary filter elements shown in FIG. 33 with the primary filter element in a fully installed position.

FIG. 36 is a schematic side cross-sectional view of the primary filter element and secondary filter element shown in FIG. 35.

FIG. 37 is a schematic first perspective view of the primary filter element shown in FIG. 19 axially aligned with the cover shown in FIG. 1.

FIG. 38 is a schematic second perspective view of the primary filter element shown in FIG. 19 axially aligned with the cover shown in FIG. 1.

FIG. 39 is a first perspective view of portions of a third example of the primary and secondary filter elements shown in FIG. 4.

FIG. 40 is a second perspective view of the primary and secondary filter element portions shown in FIG. 39.

FIG. 41 is a cross-sectional side view of the primary and secondary filter element portions shown in FIG. 39.

FIG. 42 is a first perspective view of portions of a fourth example of the primary and secondary filter elements shown in FIG. 4.

FIG. 43 is a second perspective view of the primary and secondary filter element portions shown in FIG. 42.

FIG. 44 is a cross-sectional side view of the primary and secondary filter element portions shown in FIG. 42.

FIG. 45 is a first perspective view of portions of a fifth example of the primary and secondary filter elements shown in FIG. 4.

FIG. 46 is a second perspective view of the primary and secondary filter element portions shown in FIG. 45.

FIG. 47 is a cross-sectional side view of the primary and secondary filter element portions shown in FIG. 45.

FIG. 48 is a first perspective view of portions of a sixth example of the primary and secondary filter elements shown in FIG. 4.

FIG. 49 is a second perspective view of the primary and secondary filter element portions shown in FIG. 48.

FIG. 50 is a cross-sectional side view of the primary and secondary filter element portions shown in FIG. 48.

FIG. 51 is a first perspective view of an alternative portion of the secondary filter element shown in FIGS. 19 to 23

FIG. 52 is a second perspective view of the secondary filter element portion shown in FIG. 51.

The drawings of the figures are neither drawn to scale nor proportioned. Generally, identical components are denoted by the same reference numerals in the figures.

### DETAILED DESCRIPTION

The present disclosure will be described in terms of specific embodiments, which are illustrative of the disclosure and not to be construed as limiting. It will be appreciated by persons skilled in the art that the present disclosure is not limited by what has been particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the disclosure described herein are capable of operation in other sequences than described or illustrated herein.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one ordinary skill in the art from this disclosure, in one or more embodiments.

Although a number of the drawings presented and discussed below are specifically addressing embodiments of a filter element for filtering air, the present disclosure is not limited to filter elements for filtering any particular fluid. The fluid is for example a gas such as air.

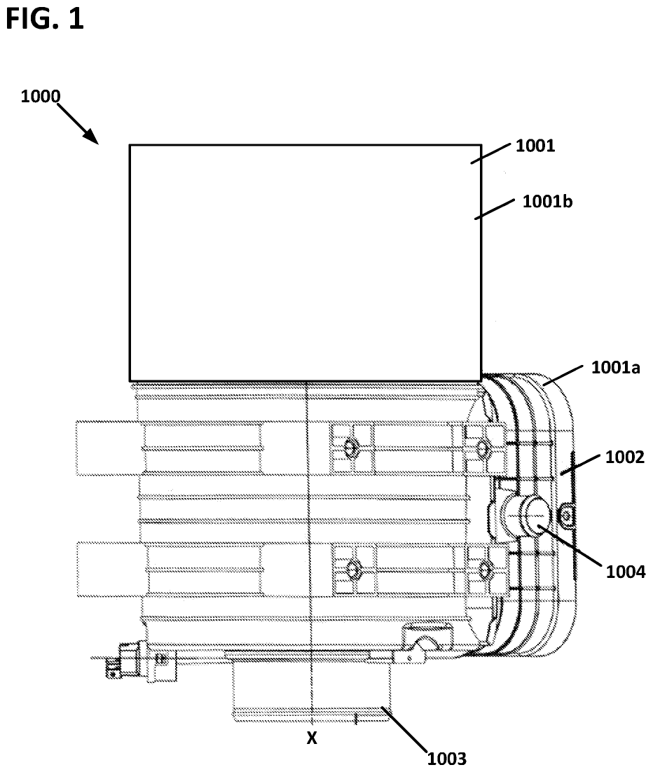

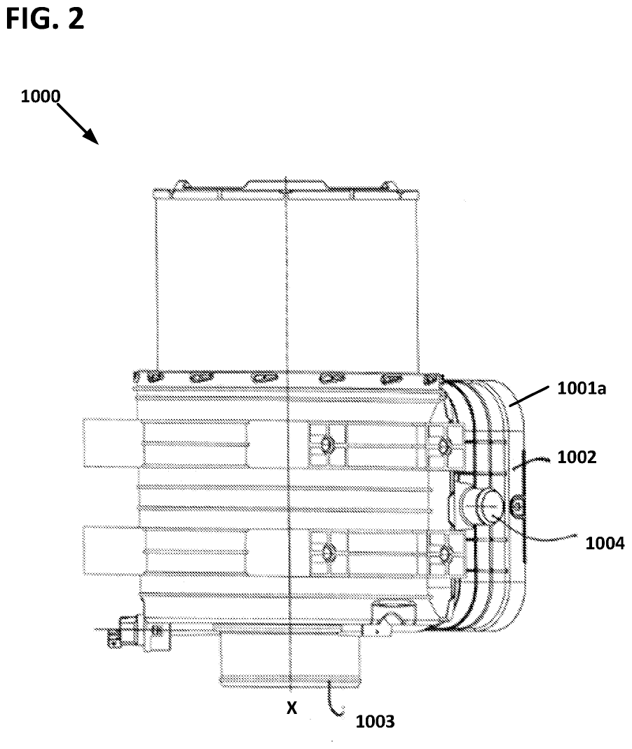

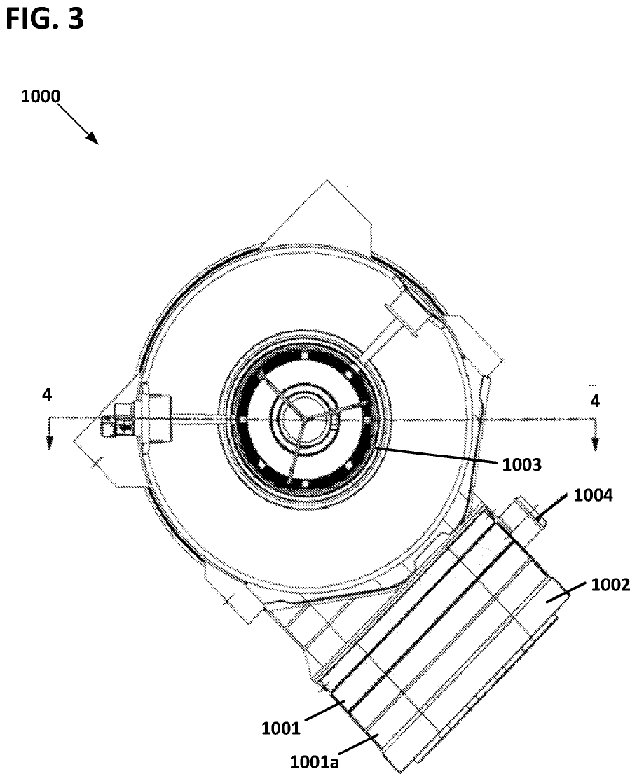

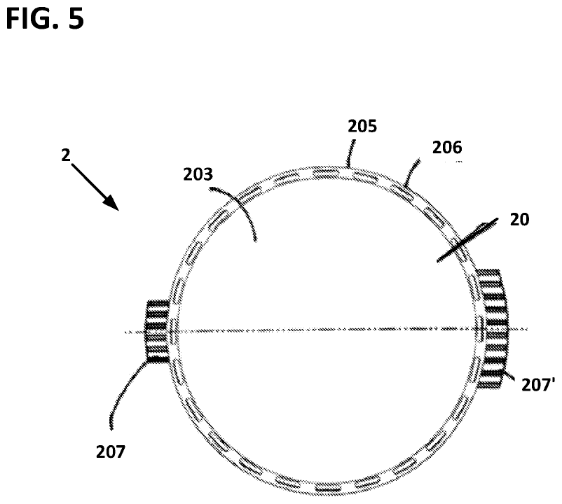

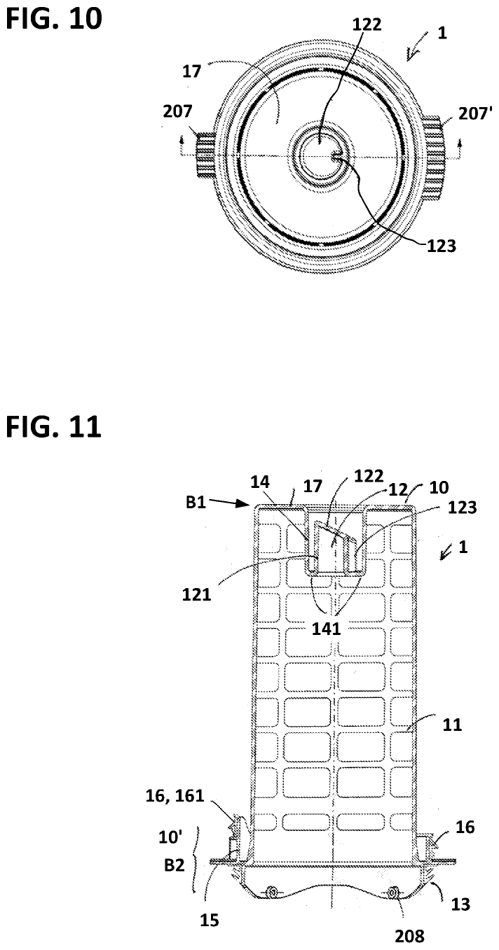

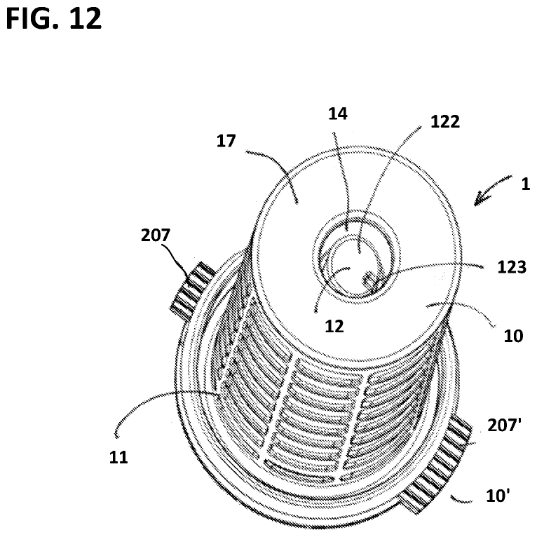

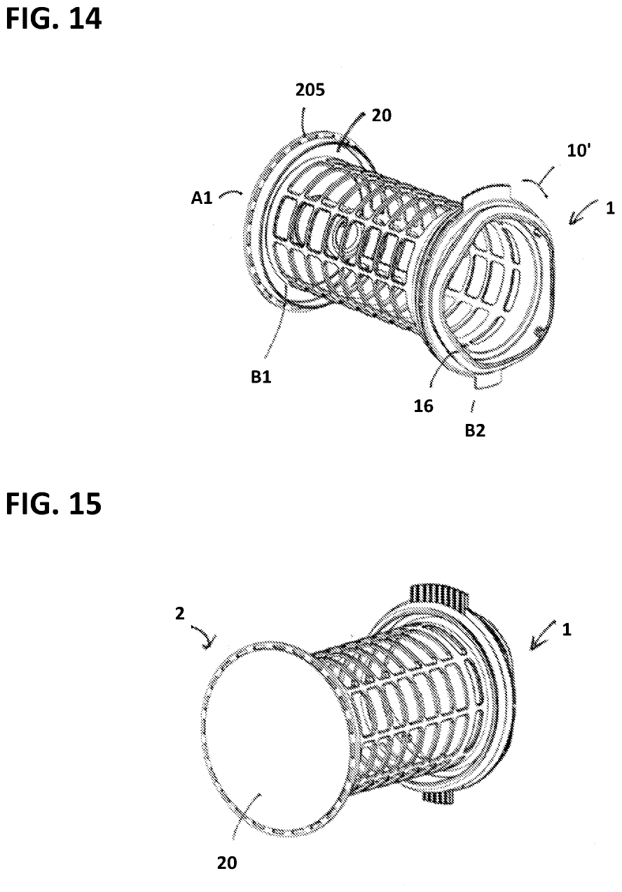

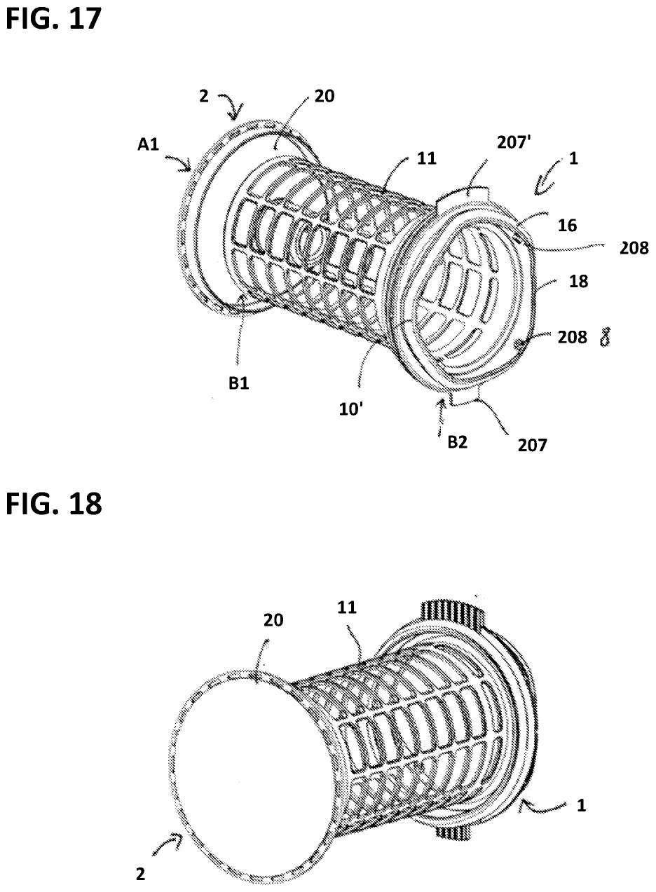

Referring to FIGS. 1 to 18, a first example of an air cleaner assembly 1000 of the present disclosure is presented. As shown, the air cleaner assembly 1000 includes a housing assembly 1001 including a main housing part 1001a and a cover part 1001b. The air cleaner 1000 also includes a primary filter element 2 and a secondary filter element 1 coaxially arranged about an axis X, for instance the housing axis X, within the housing 1001 and along a fluid flow path between an inlet 1002 of the housing 1001 and an outlet 1003 of the housing 1001. In one aspect, both the primary and secondary elements 2, 1 comprise respective first and second filter media packs or arrangements 200, 100, each extending between a respective closed first end cap 20, 10 at a first end A1, B1 and a respective second end cap 20′, 10′ at a second end A2, B2 of the filter media packs. An outer surface of the closed first end cap 10 of the secondary element 1 is adapted and arranged for interacting with an inner surface of the closed first end cap 20 of the primary filter element 2 during installation of the primary filter 2 element so as to convert a pushing force exerted on the primary element 2 towards the secondary element 1 into a rotational movement of the primary element 2 up until a first predetermined angular position, followed by a translational movement of the primary filter element 2 towards the secondary filter 1 element in a direction along the axis, such as the housing axis, when the first predetermined angular position is reached.

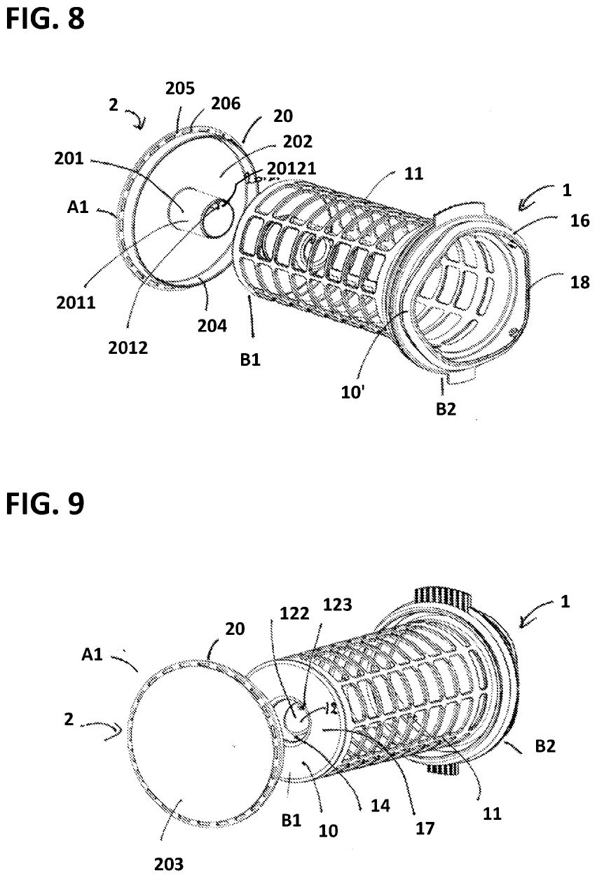

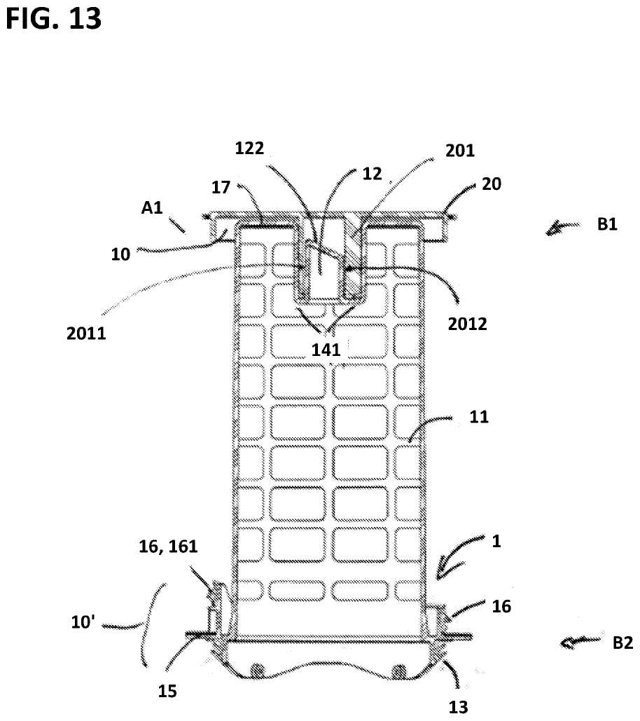

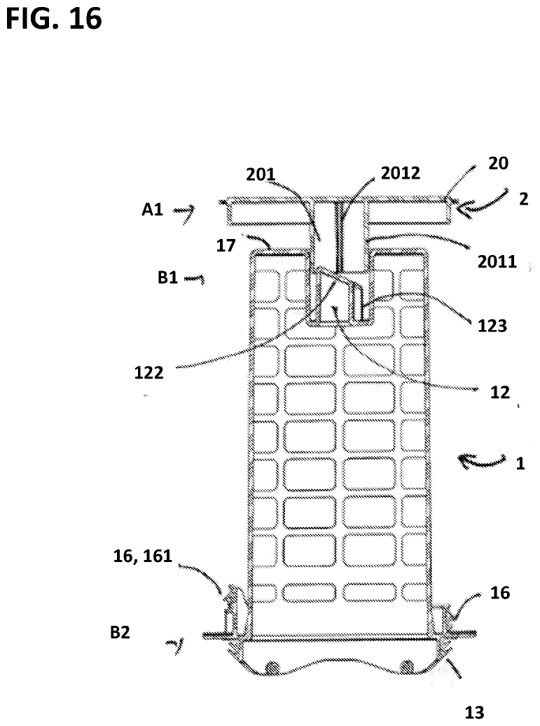

The figures also include illustrations of the interaction between the primary filter element 2 and the secondary filter element 1 at different moments of the installation process. For example, FIGS. 8 and 9 illustrate the situation where the primary filter element 2 is slid over the secondary filter element 1 before the interaction between their respective first end cap features takes place, i.e., before they contact each other. FIGS. 13 to 15 illustrate the situation where the primary filter element 2 has reached its final position after the guided interaction between their respective first end caps, first towards a predetermined angular position around the housing axis, later towards a predetermined axial position in a direction parallel to the housing axis. FIGS. 16 to 18 illustrate an intermediate situation where the first end cap of the secondary filter element is guiding the end cap of the primary filter element towards a predetermined angular position, i.e., before the predetermined angular position around the housing axis X of the housing 1001 has been reached.

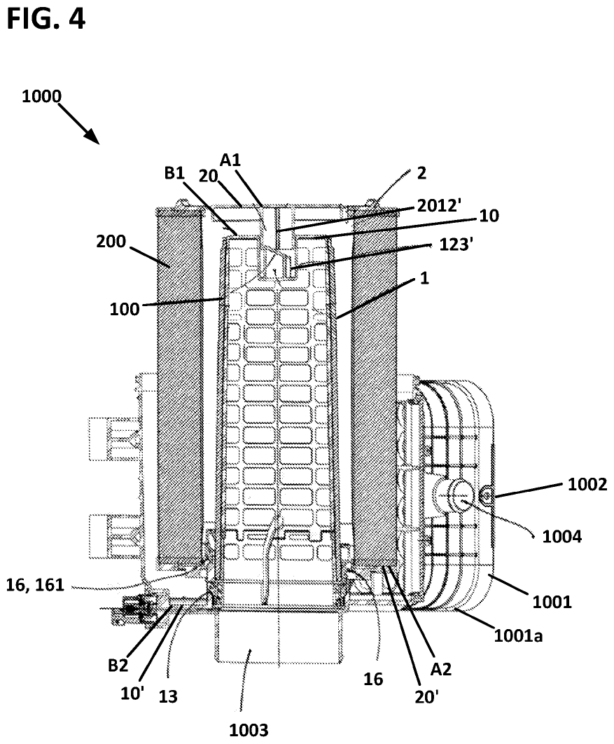

For simplification purposes, the primary filter element 2 has often been represented by its first end cap 20, when related features have been illustrated. Filter media 100, 200 has often not been depicted, but is supposed to be included in both primary 200) and secondary 100 filter elements. Filter media can be any suitable state of the art filter media such as preferably sheet filter media and/or pleated (sheet) filter media, as further described below. Also, the second end B2 of the primary filter element 2 has often not been depicted but is in preferred embodiments as described in relation with FIGS. 4, 19, and 30, for all of the preferred embodiments, such as for the first and the second preferred embodiment. The housing and the interaction with the housing, for instance at the second ends of the first and second filter elements is illustrated also in FIG. 36 for all of the preferred embodiments, such as for the first and the second preferred embodiment.

In one aspect, the first end cap 20 of the primary filter element 2 comprises a centrally positioned, inwardly protruding support structure 201 and a guiding structure 2012 radially extending from a longitudinal, cylindrical sidewall 2011 of the support structure 201. It comprises an outer surface 203, an inner surface 202, and optionally, a circumferential flange 205. The flange 205 can optionally be provided with openings 206. The end cap 20 can also comprise an axially extending circumferential ring 204. The flange 205 and/or ring 204 can, for instance, provide suitable anchoring structures for a potting material applied at the first end A1 to connect the end cap 20 with the filter media 200.

The guiding structure 2012 comprises of a rib or fin radially extending from the inwardly protruding support structure 201.

The inwardly protruding support structure 201 comprises an inwardly protruding tube-like structure. The tube-like structure comprises a cylindrical internal volume and the guiding structure 2012 extends radially inwardly from an internal surface of the sidewall 2011 of the inwardly protruding tube-like structure.

The first end cap 10 of the secondary filter element 1 comprises a slanted surface 122 for receiving the guiding structure 2012 of the primary filter element 2 and guiding it to a second predetermined angular position corresponding to the first predetermined angular position of the primary element. Preferably the slanted surface 122 is embodied as a closing end surface of a tube-like protrusion 12 of the first end cap of the secondary filter element. In such cases, the slanted surface evolves from a highest axial position to a lowest axial position over a radial extent of 180 degrees or less. Indeed, depending on the initial contact position of the guiding structure 2012 on the slanted surface 122, the sliding of the guiding structure 2012 can be clockwise or counterclockwise but will always be less then 180 degrees in order to arrive at the lowest axial position. In one aspect, the slanted surface 122 is disposed at an oblique angle to the longitudinal axis X and to a main surface of the end cap (orthogonal to the axis X) of the filter element 2. In some examples, the slanted surface 122 is disposed, with respect to the main surface at an angle of between 15 and 45 degrees, between about 20 and 35 degrees, and about 25 degrees. In one aspect, the slanted surface 122 can be characterized as being disposed at an acute angle to the main surface of the end cap.

For instance, the slanted surface 122 is embodied as an end surface of a protrusion 12 arranged in an inwardly recessed cavity in the first end cap 10. The cavity extends from a central position of the end cap 10 inwardly, from a circumferential end portion 17 of the end cap 10 and comprises a cylindrical sidewall 14 and a bottom portion 141. The protrusion 12 extends outwardly from the bottom portion 141 of the recessed cavity and has a cylindrical sidewall 121 abutting on the slanted surface 122. A receiving structure 123 is an elongate recess in the axial direction, positioned laterally in the cylindrical sidewall 121, arranged at the lowest axial position of the slanted surface 122. In one characterization, the guiding structure 2012 of the primary filter element 2 and the slanted surface 122/receiving structure 123 of the secondary filter element 1 can be characterized as a positioning arrangement, wherein the guiding structure 2012 defines a first part of the positioning arrangement and the slanted surface/receiving structure 123 define a complementary, interacting second part of the positioning arrangement.

The first end cap 10 of the secondary filter element comprises an axially extending receiving structure 123 for receiving the guiding structure 2012 of the primary filter element 2 when the guiding structure 2012 has reached the second predetermined angular position, e.g., at the lowest axial position of the slanted surface 122.

When the primary filter element 2 is slid over the secondary filter element 1 in the filter housing 1001, at a random relative angular orientation about the housing axis, the guiding structure 2012, for instance an axial end surface 20121 thereof, will most of the time contact the slanted surface 122 first and will be blocked in its movement in the axial direction. Upon exerting a force on the primary filter element in the direction of the housing axis, or in a direction defined by the common axis of the installed primary and secondary filter elements, the slanted surface 122 will cause a sliding of the guiding structure 2012 downhill along the slanted surface until a predetermined angular position is reached. At that position, further relative rotation of the primary filter element 2 with respect to the secondary filter element 1 is blocked as the guiding structure 2012 is received by the axially extending receiving structure 123 of the secondary filter element 1, which is arranged at the end of the slanted surface 122. The exerted force will, from that moment on, result in a pure translational movement of the primary filter element 2 with respect to the secondary filter element 1 until the axial end surface 20121 reaches an axial end surface 1231 of the receiving structure 123.

It is worth mentioning that, alternatively, when the user is lucky, the guiding structure 2012 and the receiving structure 123 are aligned right away and the first step of the alignment process can be skipped. The exerted pushing force will then result in a pure translational movement whereby the axially extending receiving structure 123 receives the guiding structure 2012 right away. In most cases, this will not be the case.

The radial gap or space between the cylindrical sidewall 14 and the cylindrical sidewall 121 of the first endcap 10 of the secondary element 1 is preferably positioned such that it closely corresponds to the position of the sidewall 2011 of the inwardly protruding tube-like structure of the primary filter element 2, and its width is preferably slightly larger than the width/thickness of the sidewall 2011, in order to obtain optimal guidance of the inwardly protruding support structure 201 during installation of the primary filter element 2.

In preferred embodiments, for example as depicted for instance in FIGS. 7 to 9, the second end B2 of the secondary filter element 1 further comprises a second end cap 10′. The second end cap 10′ comprises a circumferential seal 16 for sealing towards the primary filter element 2 near the second end B2 of the secondary filter element 1. The seal 16 can, for instance, comprise at least one axial step 161, the axial step being a portion of the seal 16 that extends in an axial direction away from a base plane defined by the rest of the seal. The primary filter element 2 comprises a corresponding circumferential sealing surface near its second end A2, the sealing surface and seal 16 being arranged and adapted as to seal in a single relative angular position about the housing axis.

The first predetermined angular position of the primary filter element corresponds to such a sealing configuration between the circumferential sealing surface of the primary filter element 2 and the circumferential seal 16 of the secondary filter element 1. The described interaction between the end cap of the primary and secondary filter elements thus causes their correct relative positioning and a correct sealing between the main and secondary filter elements. First, in the angular direction by means of the interaction between the slanted surface 122 and the guiding structure 2012. Thereafter, in the axial direction by the interaction of guiding structure 2012 with the axially extending receiving structure 123 of the secondary filter element 1. Their positioning and the positioning of their end surfaces 20121, 1231 can be predetermined such that the final installation position of the primary element 2 corresponds to the seal being optimally formed between the primary and secondary filter elements.

In the described preferred embodiments, the primary filter element itself does not comprise a seal, but only a surface arranged and adapted to be sealed on by a seal of the secondary filter element. In alternative embodiments, the main filter element comprises a seal for sealing towards the secondary element and the secondary element comprises a corresponding sealing surface for sealing towards the seal of the primary filter element.

The second end cap 10′ can further comprise a circumferential support structure 15, on which the seal or stepped seal 16 for sealing towards the primary filter element 2 is applied. The second end cap can additionally comprise a second circumferential seal 13 for sealing towards the filter housing 1001. The second circumferential seal can also be applied on the support structure 15. The seals 13 and 16 are preferably lip seals or other seals known to the skilled person. The seals can for instance comprise or be made of TPE (Thermo Plastic Elastomer). The support structure can for instance comprise a plastic material. An axial end face 18 of the support structure 15 may have a stepped shape following and corresponding to the one or more steps 161 of the circumferential seal 16.

The second end cap 10′ may also comprise, fully optionally, one or more coupling structures 208 for coupling and/or aligning the secondary filter element 1 with respect to the filter housing 1001. They may for instance be arranged on an internal surface of the support structure 15.

The second end cap 10′ may also comprise, optionally, one or more radially extending wings 207, 207′ which may, for instance, serve for alignment purposes between main element 2 and housing 1001. The radially extending wings 207, 207′ can extend radially from and be part of the support structure 15. The optional wings can also be used for additional and possibly second order or finer alignment between the primary filter element 2 and the secondary filter element 1, after the alignment process by interacting between the respective first end caps 10, 20 has taken place.

The first and second end caps 10′, 20′ of the secondary filter element 1 are connected by a tubular support structure of grid 11, which is adapted for allowing gas to flow through and to support the filter media 100 of the secondary filter element 1.

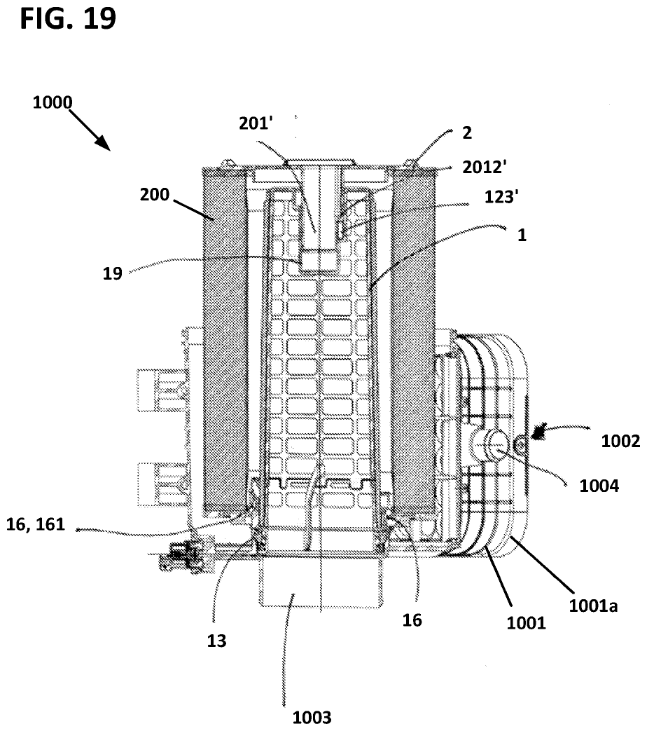

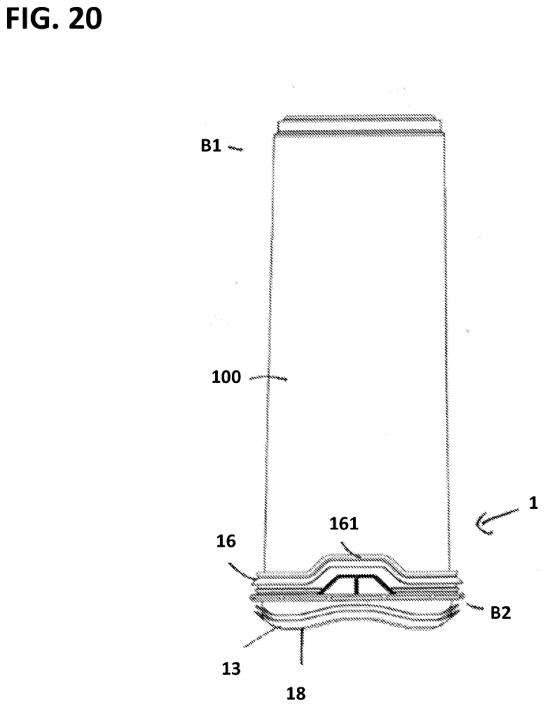

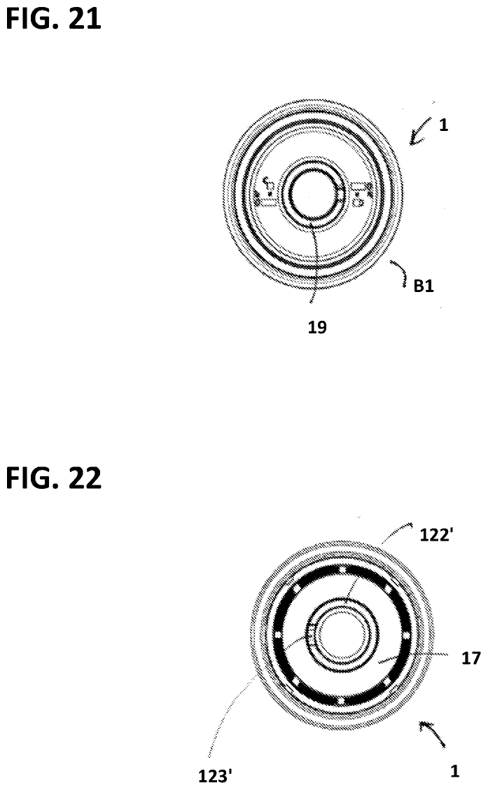

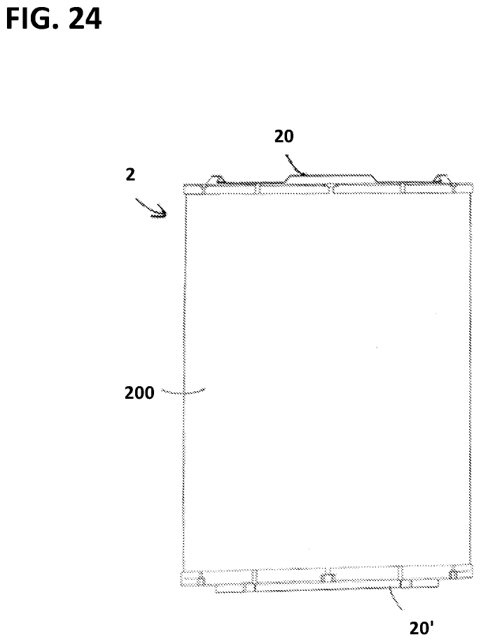

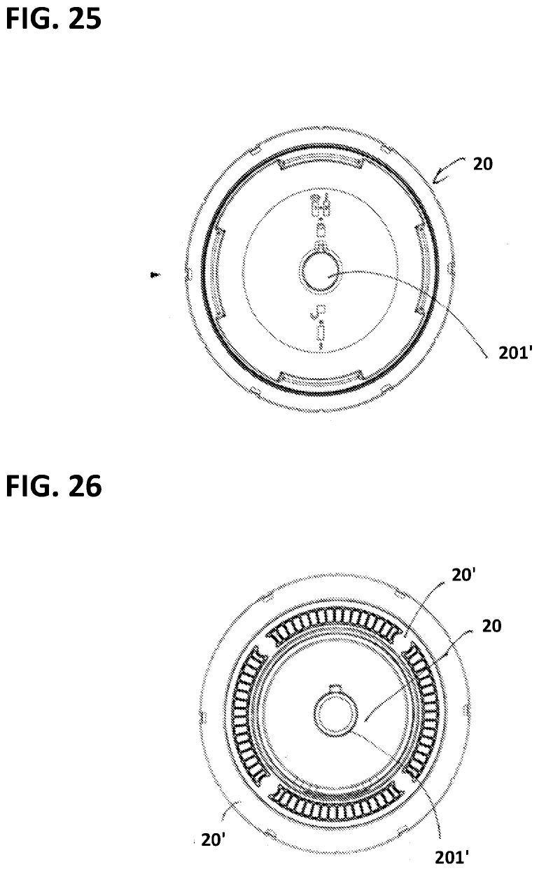

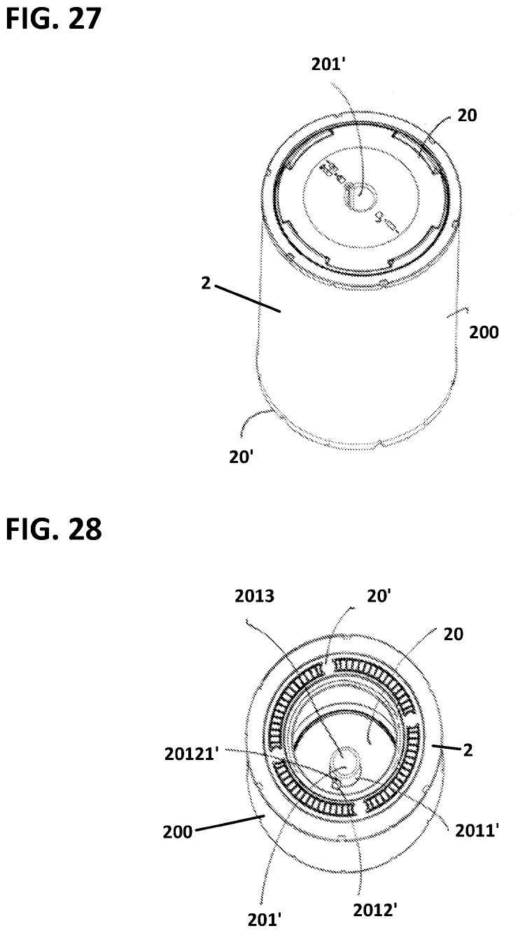

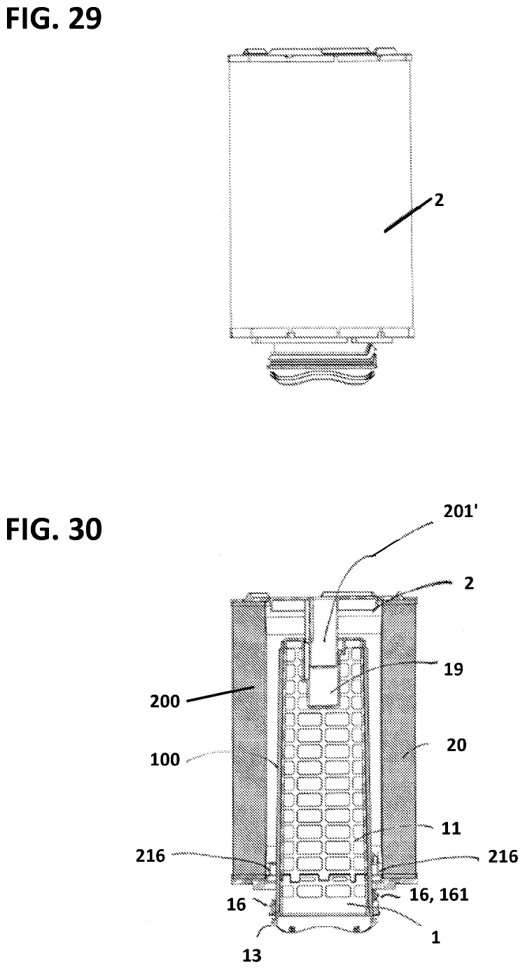

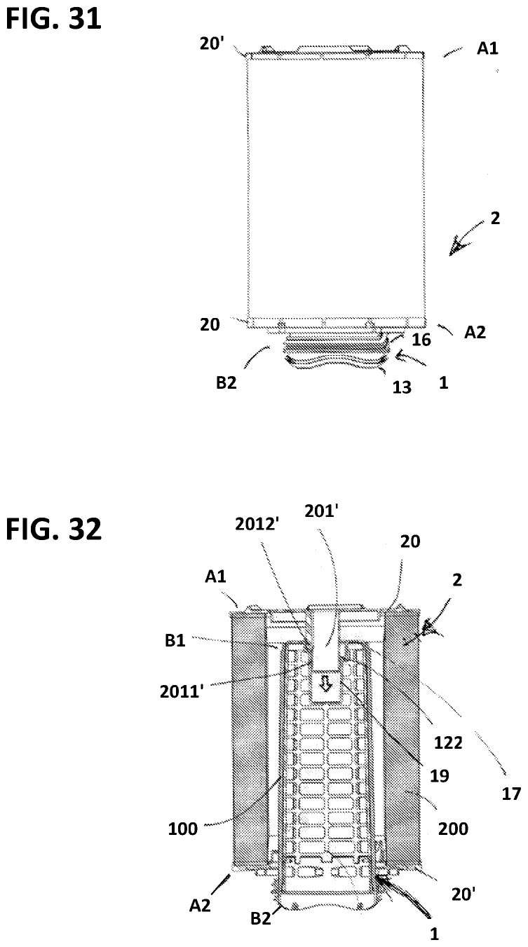

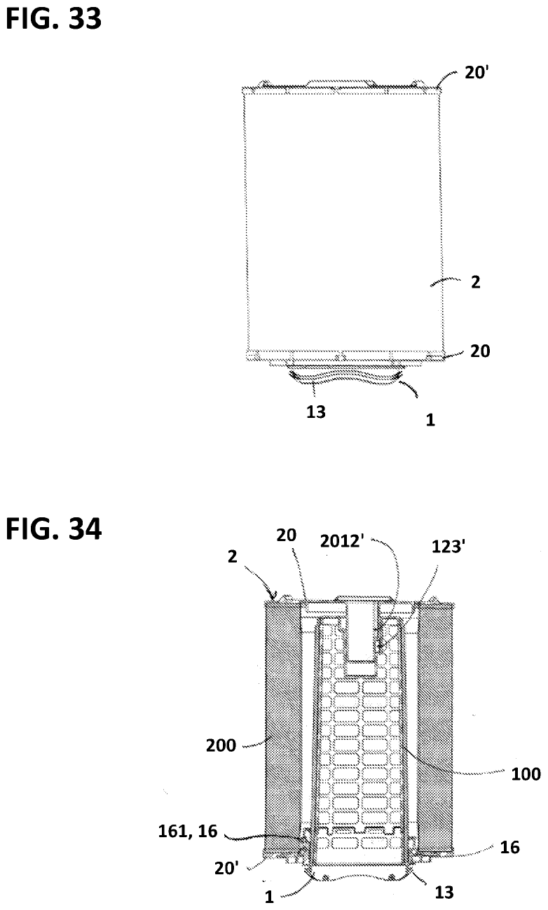

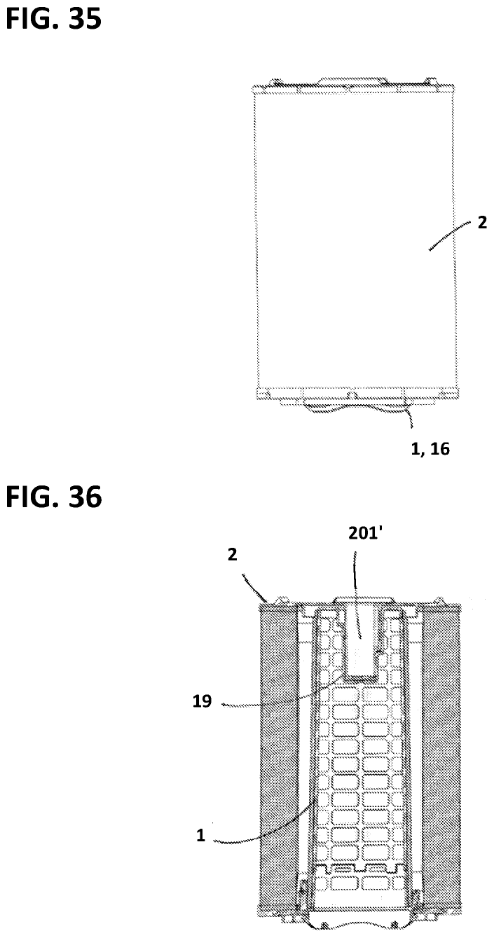

FIGS. 19 to 38 disclose views and cut-views of a second preferred embodiment of a filter assembly 1000 of the present disclosure. It also includes illustrations of the interaction between the primary filter element 2 and the secondary filter element 1 at different moments of the installation process. FIGS. 29 and 30 illustrate the situation where the primary filter element 2 is slid over the secondary filter element 1 and their respective first end cap features initially contact each other, at the highest point of the slanted surface 122′. FIGS. 31 and 32 illustrate the situation where the primary filter element 2 is slid over the secondary filter element 1 and their respective first end cap features (e.g., initially) contact each other, at 90 degrees from the highest point of the slanted surface 122′. FIGS. 33 and 34 illustrate the situation where the main element is at the end of the slanted surface at the lowest end of the rotation and therefor at the final relative angular position, from where a purely relative translational movement can start. FIGS. 35 to 36 illustrate the situation where the primary filter element 2 has been displaced axially into the final installed position.

The second preferred embodiment of the present disclosure is similar to the first preferred embodiments, and differs therefrom in: the nature of the inwardly protruding support structure 201′ and the guiding structure 2012′ radially extending from a longitudinal sidewall 2011′ of the support structure; the nature of the slanted surface 122′ for receiving the guiding structure 2012′ of the primary filter element 2 and guiding it to a second predetermined angular position corresponding to the first predetermined angular position of the primary element 2.

In this case, the guiding structure 2012′ extends radially outwardly from an external surface of a longitudinal sidewall 2011′ of the inwardly protruding tube-like structure 201′.

The slanted surface 122′ is embodied as a spiralling surface arranged in a recess 19 of the first end cap 20′ of the secondary filter element 1, for instance against or/and as a cylindrical sidewall 14 of the recess 19. The recess 19 extends inwardly from an axial end surface 17 of the first end cap 20′.

The slanted surface 122′ evolves from a highest axial position 122′ H to a lowest axial position 122′ L in a spiralling way over an axial extent of more than 180 degrees, for instance, over an extent of about 360 degrees.

When the primary filter element 2 is slid over the secondary filter element 1 in the filter housing 1001, at a random relative angular orientation about the housing axis, the guiding structure 2012′, for instance an axial end surface 20121′ thereof, will most of the time contact the slanted surface 122′ first and will be blocked in its movement in the axial direction. Upon exerting a force on the primary filter element 2 in the direction of the housing axis, or in a direction defined by the common axis of the installed primary and secondary filter elements, the slanted surface 122′ will cause a sliding of the guiding structure 2012 downhill along the slanted surface 122′ until a predetermined angular position is reached. At that position, any further relative rotation of the primary filter element 2 with respect to the secondary filter element 1 is blocked as the guiding structure 2012′ is received by the axially extending receiving structure 123′ of the secondary filter element 1, which is arranged at the end of the slanted surface 122′. The exerted force will, from that moment on, result in a pure translational movement of the primary filter element 2 with respect to the secondary filter element 1 until the axial end surface 20121′ reaches an axial end surface 123′ B of the receiving structure 123′.

Other features, effects and advantages are similar to those described for the first preferred embodiments, and are included also for the second preferred embodiment. For instance, the arrangements and interactions of the seals 16, 13 and sealing surfaces at the second ends A2, B2 of the primary and secondary filter elements are the same. A correct sealing configuration between the first and second elements can be ascertained when the primary element reaches its final position.

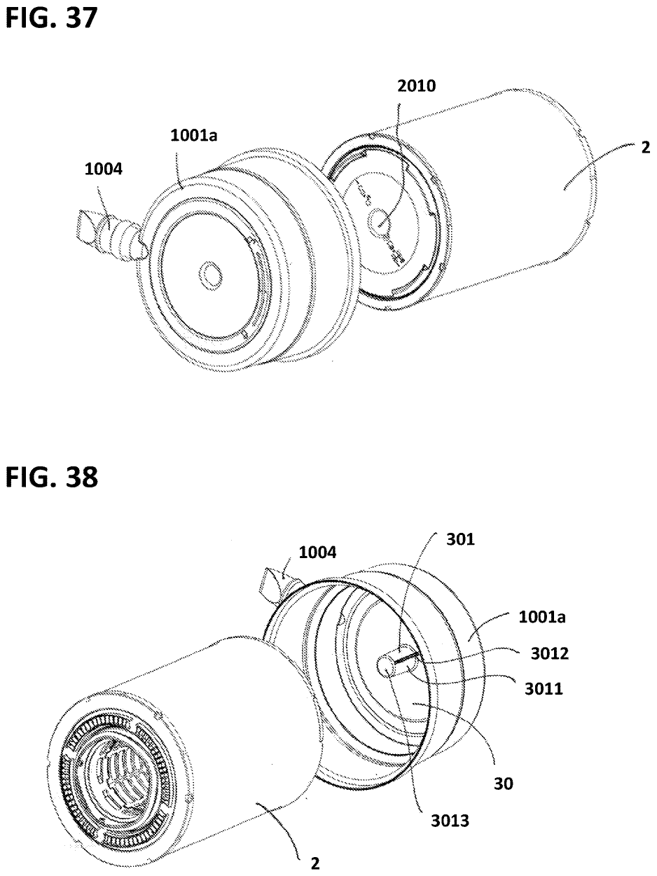

Optionally, and as illustrated in FIGS. 37 and 38, the filter assembly 1000 can further comprise a housing cover 1001b which comprises a cover guiding structure 3012 adapted and arranged to interact with the inwardly protruding support structure 201 and the guiding structure 2012′ of the primary filter element 2 so as to define a single relative angular position with respect to the primary filter element 2. This can be advantageous for instance for determining a correct positioning of the cover 1001b, for instance, of an evacuation valve 1004 present thereon.

The guiding structure 2012′ of the primary filter element 2 extends radially outwardly from an external surface 2011′ of the inwardly protruding tube-like structure 201′, and the inwardly protruding tube-like structure 201′ abuts on an axial end surface 2013, an internal surface of the inwardly protruding tube-like structure 201′ and of the guiding structure 2012′ and of the axial end surface 2013 defining a pocket. The internal surface of the guiding structure 2012′ of the primary filter element defines an axially extending recess of the pocket. The housing cover 1001b comprises an axially inwardly directed cover protrusion 301 and a cover guiding structure 3012 extending radially from an outer wall 3011 of the axially inwardly directed cover protrusion 301 and extending axially along a direction parallel to the housing axis. The pocket is adapted for receiving the axially inwardly directed cover protrusion 301 in a predetermined relative angular orientation, the predetermined relative angular orientation being defined by the reception of the cover guiding structure 3012 into the axially extending recess of the pocket.

In both the first and second preferred embodiments, the second end cap 20′ of the primary filter element 2 can further comprise axially extending element locking features and the filter housing 1001 can comprise corresponding housing locking features suitable for receiving the filter locking features and cooperating with them in order to block any relative rotation of the primary filter element with respect to a housing axis, the locking features being arranged and adapted to provide the rotational locking after the primary element has reached the first predetermined angular position and before the end of the translational movement.

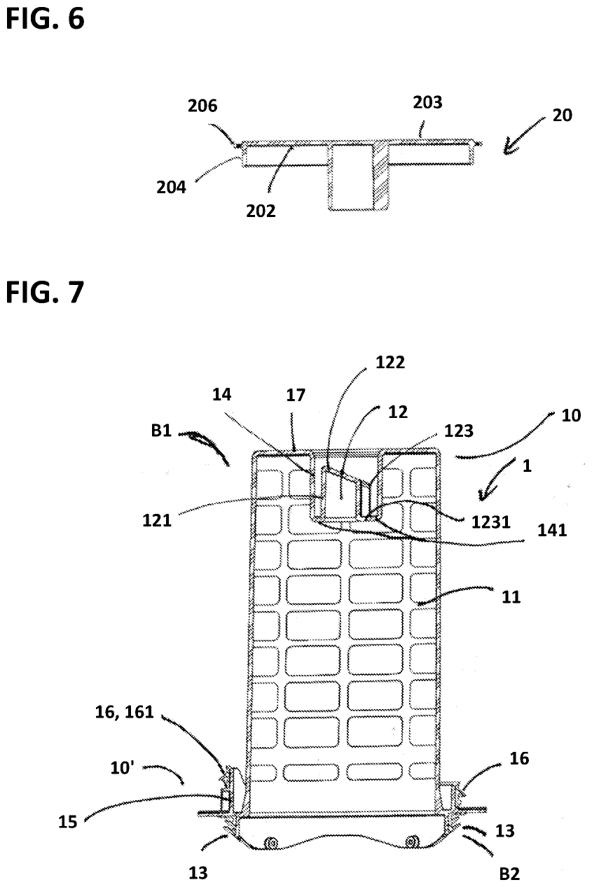

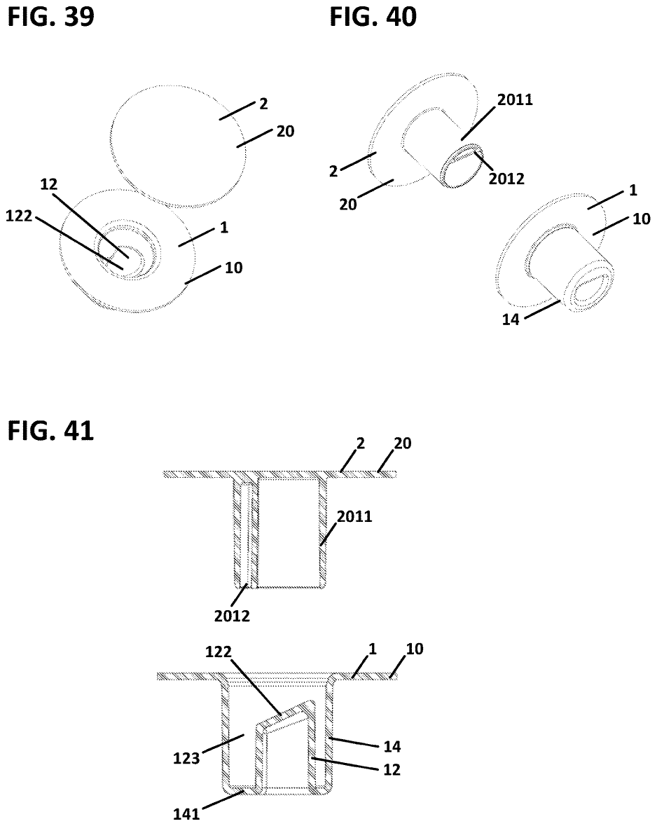

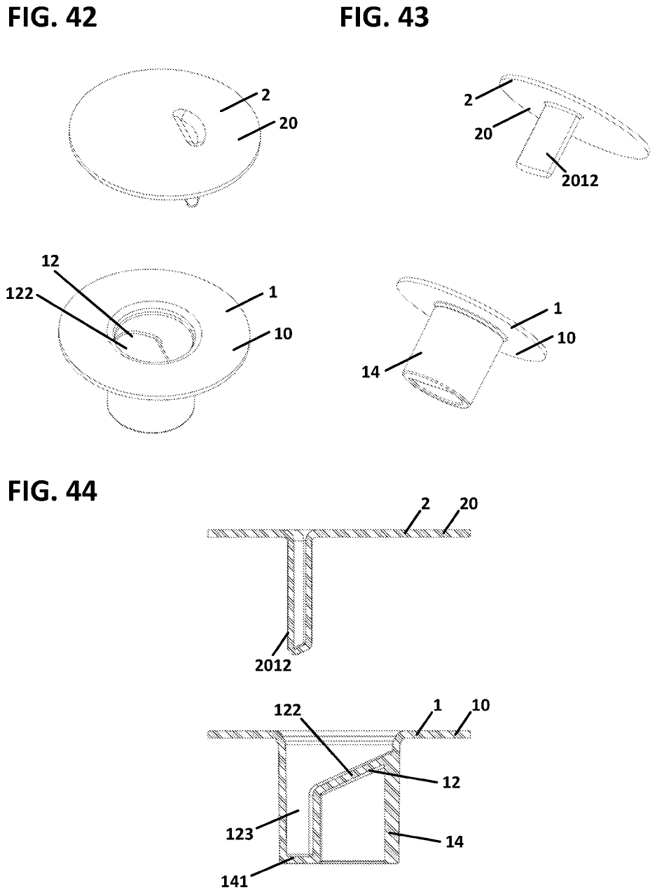

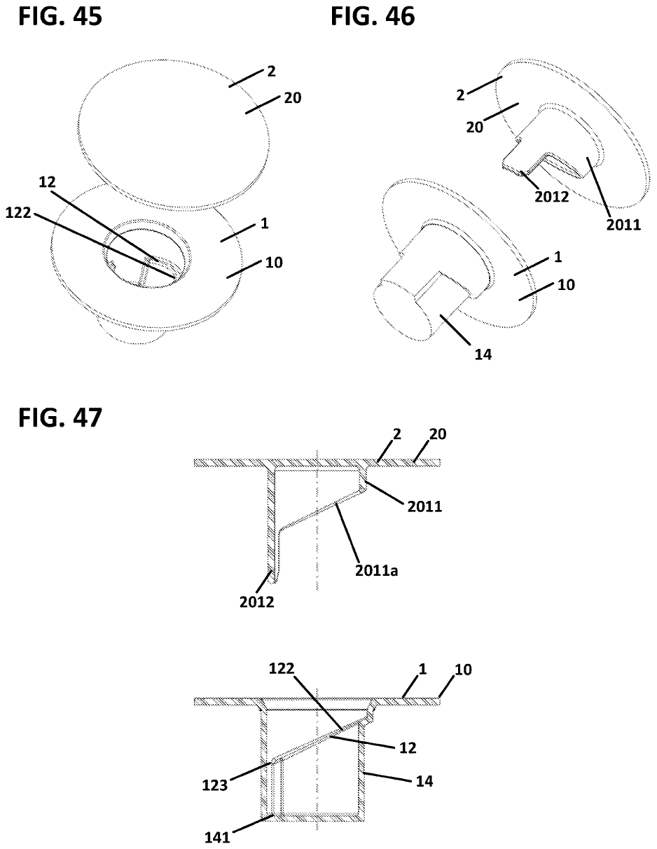

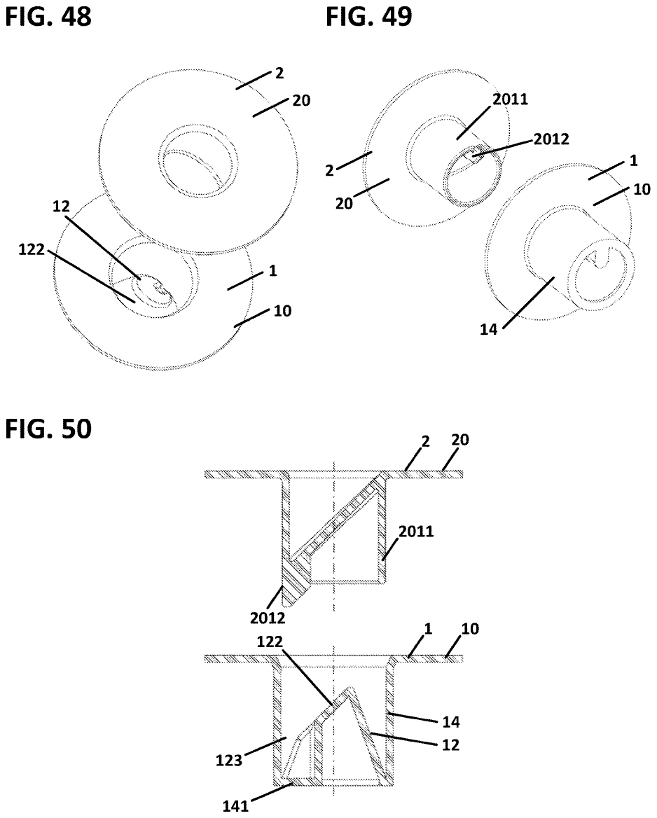

Referring to FIGS. 39 to 50, additional examples of possible configurations for end caps 10, 20 in which various sidewall and guiding structures 2011, 2012 are provided on the end cap 20 associated with the main filter element 2 and in which various corresponding protrusions 12, sidewall structures 14, and slanted surfaces 122 are provided on the end cap 10 associated with the secondary filter element 1. With reference to FIGS. 39 to 40, an example is shown in which the sidewall structure 2011 is cylindrical and the guiding structure 2012 can be characterized as having a flat, axially extending sidewall that is a chord of the cylindrical sidewall structure 2011 such that the guiding structure can be said to have a cross-sectional shape of a circle segment. The receiving structure 123 associated with the end cap 10, and which receives the guiding structure 2012, has a corresponding circle segment cross-sectional shape. FIGS. 42 to 44 show a configuration in which the guiding structure 2012 is formed with a cross-sectional shape that is a circle segment, wherein the sidewall structure 2011 has an arc-shape rather than being fully cylindrical. Accordingly, the receiving structure 123 is provided with a similar cross-sectional shape essentially defining a single slot. FIGS. 45 to 47 show a further configuration in which the guiding structure 2012 is provided with an arc-shaped cross-section extending axially from a cylindrical sidewall 2011, wherein the cylindrical sidewall defines a slanted axial end surface 2011a that engages with slanted surface 122. The receiving structure 123 is provided with a complementary arc-shaped cross-section for receiving the guiding structure 2012. FIGS. 48 to 50 show a configuration similar to that shown for FIGS. 6 to 9, but in which the guiding structure 2012 is provided with a tapered end that extends beyond the cylindrical sidewall 2011, wherein a slanted surface 2011a extends between the guiding structure 2012 and the base of the sidewall structure 2011. As with the other embodiments, the end cap 10 is provided with a correspondingly shaped slanted surface 122 and receiving structure 123.

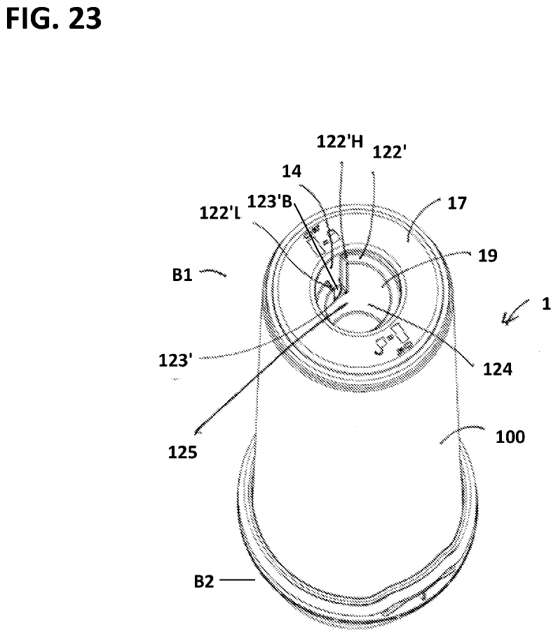

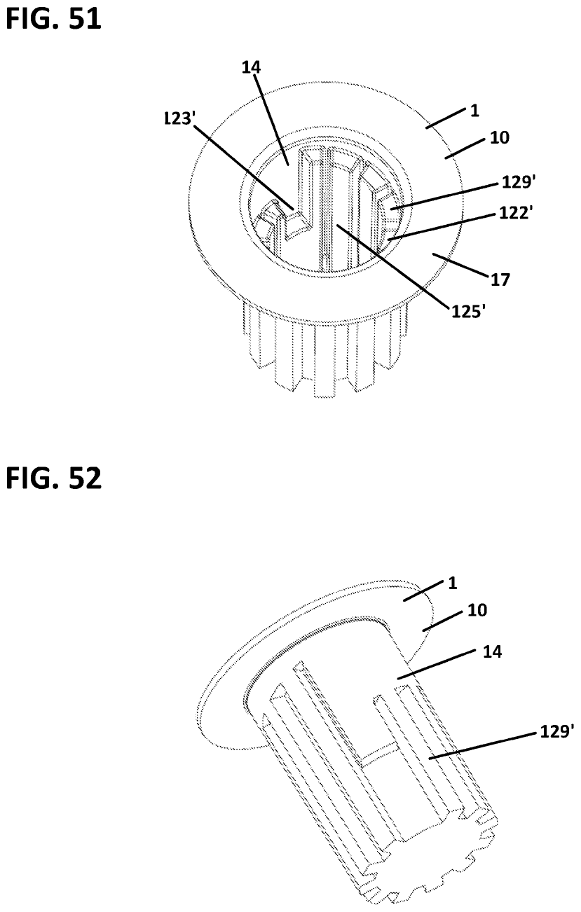

Referring to FIGS. 51 and 52, a variation of the end cap 10 shown at FIGS. 22 and 23 is shown. In contrast to the earlier embodiment, the end cap 10 at FIGS. 51 and 52 is provided with a receiving structure 123′ that has an inner sidewall 125′ and slanted surface 122′ defined by a plurality of individual and spaced apart, axially extending, three-sided wall structures 129′.

### Filter Medium Pack

The filter elements according to the present disclosure are not limited to a specific filter medium pack.

Typically, the filter medium packs 100, 200 of the filter elements 1, 2 according to the present disclosure comprise a circumferential radial side elongating along a longitudinal axis from a first axial end to a second axial end, opposite the first axial end.

In embodiments, the filter medium pack is rotationally symmetric with respect to the longitudinal axis. For example, the circumferential radial side of the filter medium pack can have a cylindrical shape.

In other embodiments, the filter medium pack can have a non-cylindrical shape, for example, where a cross-section of the filter medium pack has an oval shape or a peanut shape.

In embodiments, the filter medium pack has an inner cavity extending between the first axial end and the second axial end. The filter medium pack can for example have the shape of a hollow cylinder.

In embodiments where the filter medium pack comprises an inner cavity, after installation of the filter element in a housing of a filter system, the fluid to be filtered is crossing the filter media in a direction transverse to the longitudinal direction. For example, fluid to be filtered traverses through the circumferential radial side of the filter medium pack towards the inner cavity and filtered fluid exits the filter medium at the second axial end of the filter medium pack through the open end cap.

In embodiments, the filter media packs with an interior cavity are sheet filter media packs that can be woven or non-woven, can include synthetic and/or natural fibers, and are either pleated or non-pleated.

Typically, the pleated filter media have a plurality of pleats placed in a closed loop, for example an annulus. In this way, a hollow filter body is formed extending in a longitudinal direction. The hollow filter body has a first opening and a second opening at, respectively, a first end and a second end of the hollow filter body. The pleats are, for example, formed by folding a sheet of filter paper.

A plurality of outer tips of the plurality of pleats forming an outer circumferential perimeter of the hollow filter body and the circumferential radial side of the filter medium pack corresponds to this circumferential perimeter formed by the outer tips of the pleats. The first axial end and the second axial end of the filter medium pack corresponds to, respectively, the first and the second ends of the hollow body. In embodiments, typically the folding lines of the pleated filter media are oriented essentially parallel with the longitudinal axis.

In other embodiments, the filter medium pack can be a so-called straight-through filter medium pack wherein the filter media conducts filtration of the fluid by having the fluid crossing the filter medium pack in a flow direction from the first axial end, forming an inlet flow face, to the second axial end, forming an outlet flow face for the filter media pack.

In embodiments, the straight-through filter medium pack comprises fluted filter media, also known as Z-filter media. An example of commercially available Z-filter media is known under the name Powercore™ as manufactured by Donaldson Company, Inc.

In embodiments, the fluted filter media may be formed by coiled layers of filter material.

In embodiments, by coiling layers of filter material, a filter medium pack is obtained wherein the circumferential radial side of the filter medium pack is formed by a surface of an outer layer of the coiled filter media.

In embodiments, the filter media may be formed by coiled layers of fluted filter material wherein each of these coiled layers includes inlet flutes and outlet flutes oriented essentially parallel with the longitudinal direction. By coiling layers of fluted filter material, a filter medium pack is formed wherein the circumferential radial side of the filter medium pack is formed by a surface of an outer layer of the coiled fluted filter media.

Generally, in embodiments comprising coiled layers of fluted filter material, each of the layers of coiled fluted material include a set of inlet flutes and a set of outlet flutes. The set of inlet flutes are open at the axial inlet side of the filter body in order to receive the unfiltered fluid and the inlet flutes are closed at or toward the axial outlet side of the filter body. On the other hand, the set of outlet flutes are closed at or toward the axial inlet side and open at the axial outlet side to allow the filtered fluid to exit the filter body. In this way, the fluid is forced to make a Z-shaped trajectory to flow from the axial inlet side to the axial outlet side of the filter medium pack.

In further embodiments comprising coiled layers of filter material, an outer layer of the coiled filter material is at least partly covered with a covering comprising a separate material such as a polymeric, cellulose, or inorganic material. The covering can be embodied for instance as a wrap, sleeve or coating. The covering can for instance comprise a plastic wrap. The covering is to be construed as a protecting cover. In this way, at least a portion of the circumferential face of the filter medium pack is formed by the covering. The covering can for example be glued to the outer layer of the filter material or the covering can be an adhesive tape. In embodiments, the covering can also be thermally welded to the outer layer of the coiled layers of filter material.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A filter assembly comprising:
a) a filter housing and primary and secondary filter elements coaxially arranged about an axis within said housing along a fluid flow path between an inlet of the housing and an outlet of the housing;
b) wherein both the primary and secondary filter elements comprise respective first and second filter media packs, each extending between a respective closed first end cap at a first end and a respective second end cap at a second end of said filter media packs; and
c) wherein an outer surface of said closed first end cap of said secondary filter element is adapted and arranged for interacting with an inner surface of said closed first end cap of said primary filter element during installation of said primary filter element so as to convert a pushing force exerted on said primary filter element towards said secondary filter element into a rotational movement of said primary filter element up until a first predetermined angular position, followed by a translational movement of said primary filter element towards said secondary filter element in a direction along said axis when said first predetermined first angular position is reached.

2. The filter assembly according to claim 1, wherein
a) said first end cap of said primary filter element comprises a centrally positioned, inwardly protruding support structure and a guiding structure radially extending from a longitudinal sidewall of said support structure;
b) said first end cap of said secondary filter element comprises a slanted surface for receiving said guiding structure of said primary filter element and guiding it to a second predetermined angular position corresponding to said first predetermined angular position of said primary filter element; and
c) said first end cap of said secondary filter element comprises an axially extending receiving structure for receiving said guiding structure of said primary filter element when said guiding structure has reached said second predetermined angular position.

3. The filter assembly according to claim 2, wherein said guiding structure comprises a rib or fin radially extending from said inwardly protruding support structure.

4. The filter assembly according to claim 2, wherein said inwardly protruding support structure comprises an inwardly protruding tube-like structure.

5. The filter assembly according to claim 4, wherein said tube-like structure comprises a cylindrical internal volume and wherein said guiding structure extends radially inwardly from an internal surface of said inwardly protruding tube-like structure.

6. The filter assembly according to claim 5, wherein said slanted surface is embodied as a closing end surface of said tube-like protrusion of said first end cap of said secondary filter element.

7. The filter assembly according to claim 6, wherein said slanted surface evolves from a highest axial position to a lowest axial position over a radial extent of less than 180 degrees.

8. The filter assembly according to claim 4, wherein said guiding structure extends radially outwardly from an external surface of said inwardly protruding tube-like structure.

9. The filter assembly according to claim 5, wherein said slanted surface is embodied as a spiralling surface arranged in a recess of said first end cap of said secondary filter element.

10. The filter assembly according to claim 9, wherein said slanted surface evolves from a highest axial position to a lowest axial position in a spiralling way over an axial extent of no more than 180 degrees.

11. The filter assembly according to claim 9, wherein said slanted surface evolves from a highest axial position to a lowest axial position in a spiralling way over an axial extent of less than 180 degrees.

12. The filter assembly according to claim 1, wherein said second end cap of said primary filter element comprises axially extending element locking features and wherein said filter housing comprises corresponding housing locking features suitable for receiving said filter locking features and cooperating with them in order to block any relative rotation of said primary filter element with respect to a housing axis, said locking features being arranged and adapted to provide said rotational locking after said primary filter element has reached said first predetermined angular position and before the end of said translational movement.

13. The filter assembly according to claim 1, wherein said secondary filter element comprises a circumferential seal for sealing towards said primary filter element near said second end of said secondary filter element, and wherein said primary filter element comprises a circumferential sealing surface near its second end, the sealing surface and seal being arranged and adapted to seal in a single or a limited number of relative angular positions.

14. The filter assembly according to claim 13, wherein said first predetermined angular position of said primary filter element corresponds to a sealing configuration between said circumferential sealing surface of said primary filter element and said circumferential seal of said secondary filter element.

15. The filter assembly according to claim 13, wherein said circumferential seal comprises at least one axial step.

16. The filter assembly according to claim 4, further comprising a housing cover which comprises a cover guiding structure adapted and arranged to interact with said inwardly protruding support structure and said guiding structure of said primary filter element so as to define a single relative angular position with respect to said primary filter element.

17. The filter assembly according to claim 16, wherein said guiding structure of said primary filter element extends radially outwardly from an external surface of said inwardly protruding tube-like structure, wherein said inwardly protruding tube-like structure abuts on an axial end surface, an internal surface of said inwardly protruding tube-like structure and said guiding structure and said axial end surface defining a pocket, said internal surface of said guiding structure of said primary filter element defining an axially extending recess of said pocket, wherein said housing cover comprises an axially inwardly directed cover protrusion and a cover guiding structure extending radially from an outer wall of said axially inwardly directed cover protrusion, wherein said pocket is adapted for receiving said axially inwardly directed cover protrusion in a predetermined relative angular orientation, said predetermined relative angular orientation being defined by the reception of said cover guiding structure into said axially extending recess of said pocket.

18. A filter element for use in an air cleaner assembly, the filter element comprising:
a) a media pack extending between a closed first end cap at a first end and a second end cap at a second end;
b) a support structure centrally positioned on the first end cap and protruding inwardly in a longitudinal direction towards the second end cap; and
c) a guiding structure radially extending from a longitudinal sidewall of said support structure.

19. The filter element according to claim 18, wherein said guiding structure comprises a rib or fin radially extending from said inwardly protruding support structure.

20. The filter element according to claim 18, wherein said inwardly protruding support structure comprises an inwardly protruding tube-like structure.

21. The filter element according to claim 20, wherein said tube-like structure comprises a cylindrical internal volume and wherein said guiding structure extends radially inwardly from an internal surface of said inwardly protruding tube-like structure.

22. The filter element according to claim 20, wherein said guiding structure extends radially outwardly from an external surface of said inwardly protruding tube-like structure.

23. The filter element according to claim 18, wherein said filter element does not comprise a seal.

24. The filter element according to claim 18, wherein said second end cap comprises axially extending element locking features, such as at least one or a plurality of axially extending locking pins, or openings for receiving locking pins.

25. The filter element according to claim 18 wherein said first end cap comprises a slanted surface for receiving said guiding structure and for guiding it to a predetermined angular position, and comprises an axially extending receiving structure for receiving said guiding structure when said guiding structure has reached a second predetermined position.

26. The filter assembly according to claim 4, further comprising a housing cover including an axially inwardly directed cover protrusion and a cover guiding structure extending radially from an outer wall of said axially inwardly directed cover protrusion.

27. An air cleaner assembly comprising:
a) a filter housing assembly defining an inlet and an outlet;
b) a primary filter element disposed within the housing and along a fluid flow path between the housing inlet and outlet, the primary filter element including a first media pack;
c) a secondary filter element coaxially arranged with the primary filter element within the housing and along the fluid flow path, the secondary filter element including a second media pack; and
d) a positioning arrangement including a first part associated with the primary filter element and a second part associated with the secondary filter element, wherein the first part interacts with the second part such that, during installation of the primary filter element, a pushing force on the primary filter element in a direction towards said secondary element is converted into a rotational movement of the primary filter element up until a first predetermined angular position, followed by a translational movement of the primary filter element towards said secondary filter element in a direction along an axis when the first predetermined angular position is reached.

28. The air cleaner assembly of claim 27, wherein the first part is a radially inward facing surface defined by the primary filter element.

29. The air cleaner assembly of claim 28, wherein the radially inward facing surface is defined by an end cap of the primary filter element.

30. The air cleaner assembly according to claim 27, wherein the second part is a radially outward facing surface defined by the secondary filter element.

31. The air cleaner assembly of claim 30, wherein the radially outward facing surface is defined by an end cap of the secondary filter element.

32. The air cleaner assembly according to claim 27, wherein one or both of the first and second parts includes a slanted surface.

33. The air cleaner assembly according to claim 27, wherein one or both of the first and second parts has single fold rotational symmetry.

34. The air cleaner assembly according to claim 27, wherein one or both of the primary and secondary filter elements has single fold rotational symmetry.
